(19) United States
(12) Patent Application Publication
(10) Pub. No.: US 2016/0265268 A1
(43) Pub. Date: Sep. 15, 2016

(54) Corner for a screen frame

(71) Applicant: Gerard Therrien, St-Apollinaire (CA)

(72) Inventor: Gerard Therrien, St-Apollinaire (CA)

(21) Appl. No.: 14/544,997

(22) Filed: Mar. 13, 2015

(51) Int. Cl. E06B 3/968; E06B 9/52

(52) U.S. Cl. CPC E06B 3/9682; E06B 9/52; E06B 2009/527

(57) ABSTRACT

A corner member for use in connecting two screen frame members together, the corner members having first and second mutually connected legs with each of the legs incorporating a leaf spring therein such that when the legs are inserted into the screen frame members, the leaf spring is compressed and functions to retain the screen frame member in position.

### FIELD OF THE INVENTION

The present invention relates to screens suitable for use with windows or the like and more particularly, relates to screen frames and corner members therefore.

### BACKGROUND OF THE INVENTION

In modern day windows, a screen is usually provided as a part of the original window. Desirably, the screen member will be lightweight and easily moved into and out of position such that access may be had to the glass portion of the window. Normally, the screen member is formed by frame members along the top, bottom and sides. The frame members are joined together by suitable means—this is frequently accomplished by use of what is known as a screen frame corner member.

A number of different designs of screen frame corner members are known in the art. While they basically all perform the same function of attaching the frame members together, they do so in different ways.

There are also a number of different ways for retaining the screen member in the window frame. It is known in the art to have a window frame which provides a recess of one form or another designed to receive the window screen. In order to permit the insertion of the screen in the window frame and to retain the same in position, various types of locking arrangements may be utilized. Since there are few standards which exist, each manufacturer generally adopts his own method for retaining the screen in position.

### SUMMARY OF THE INVENTION

It is an object of the present invention to provide a frame for a window screen which has members at the top and bottom to retain the screen in a desired position while also allowing for easy removal thererof.

It is a further object of the present invention to provide a corner member suitable for connecting screen frame members together and which corner member is designed to securely retain the same members in position.

According to one aspect of the present invention, there is provided a frame for a screen comprising four screen frame members, four corner members interconnecting the four screen frame members to form a rectangular screen frame, each of the four corner members having a movable member associated therewith, the movable member having an elongated configuration with a first end being within said corner member and a second end extending outwardly from the respective corner member, the second end having a triangular configuration with first and second sloping sides meeting at an apex.

According to a further aspect of the present invention, there is provided a corner member for use in connecting two screen frame members together, the corner member having first and second mutually connected legs, the first and second legs extending perpendicularly to each other, each of the legs having a main body portion and a leaf spring extending upwardly from one side of the main body portion, the leaf spring being slightly spaced from a portion of the one side of the main body portion, the arrangement being such that when each of the legs is inserted into one of the screen frame members, the leaf spring functions to retain the screen frame member in position.

The corner member of the present invention can be formed of different materials although plastic is a preferred material as it has many ideal properties. As is known in the art, the corner member of first and second mutually connected legs with each of the legs extending perpendicularly to each other. Each of the legs is designed to fit within a frame member to permit interconnecting of two frame members at a right angle. While a problem exists in conventional corner members in that they do not securely retain the frame member thereon, the present invention utilizes a leaf spring on one of the walls. The leaf spring will flex inwardly when inserted into the screen frame member and will exert an outward pressure thereon to retain the corner and the frame member in a desired relationship.

The frame of the present invention preferably utilizes a unique movable member which has a first portion mounted within the corner member and a second end which extends outwardly and which is designed to engage the frame of the window.

### BRIEF DESCRIPTION OF THE DRAWINGS

Having thus generally described the invention, reference will be made to the accompanying drawings illustrating an embodiment thereof, in which:

FIGS. 1A, 1B and 1C are side elevational views of a corner member illustrating movement of the leaf spring;

FIG. 2 is an exploded view of a frame utilizing the corner members of the present invention;

FIGS. 3A, 3B and 3C illustrate the insertion of a corner member into a frame member;

FIGS. 4A and 4B are perspective views of a corner member according to an embodiment of the present invention;

FIGS. 5A, 5B and 5C illustrate the joining of two frame members utilizing a corner member;

FIGS. 6, 7 and 8 illustrate the sequence of inserting an assembled frame into a window frame or the like;

FIGS. 9, 10 and 11 show insertion of an assembled screen frame into a window frame or the like; and

FIG. 12 is a perspective view of an assembled frame.

### DETAILED DESCRIPTION OF THE INVENTION

Referring to the drawings in greater detail and by reference characters thereto, the present invention includes a corner member which is generally designated by reference numeral 10. Corner member 10 has a first leg generally designated by reference numeral 12 and a second leg generally designated by reference numeral 14. First leg 12 and second leg 14 are mutually perpendicular. Each of legs 12 and 14 are identical in structure and hence the same root reference numerals will be utilized to describe the same structure in each leg. The orientation of the legs in the drawings can appear different depending upon the placement of a movable latching member 32 which will be described hereinbelow. As will be seen, latching member 32 may be placed in either of the legs depending upon the desired requirement.

First leg 12 includes a first side wall 16 and a second parallel side wall 18. First side wall 16 has a greater height than second side wall 18 which has a curved side wall portion 20 to extend upwardly to a top wall 22.

Top wall 22 includes a leaf spring 24 with an aperture 26 formed between leaf spring 24 and a wall.

At the rear of the first leg 12 and second leg 14, there is provided a transverse wall 28 which extends between first side wall and second side wall 18. An aperture 30 is formed in transverse wall 28 for reasons which will become apparent hereinbelow.

The corner includes a movable latching or retaining member generally designated by reference numeral 32. Movable retaining member 32 has a front wall 34 and a rear wall 36. A pair of side walls 38, 40 extend between front wall 34 and rear wall 36. At one extremity, there is provided a first sloping top wall 42 and a second sloping top wall 44 which meet at an apex 45. It will be noted that the slope of top walls 42, 44 are different with sloping top wall 42 having a gentler slope while top wall 44 has a somewhat arcuate configuration.

At the other extremity, movable retaining member 32 has a shaft 46. An enlarged end 48 is provided at the extremity of shaft 46 and a coil spring extends around shaft 46. Enlarged end 48 is designed to fit within aperture 30 of transverse wall 28. In this regard, aperture 30 may have an irregular shape such as an elongated rectangular shape such that enlarged end 48 may be inserted therein and rotated which will lock the same in position.

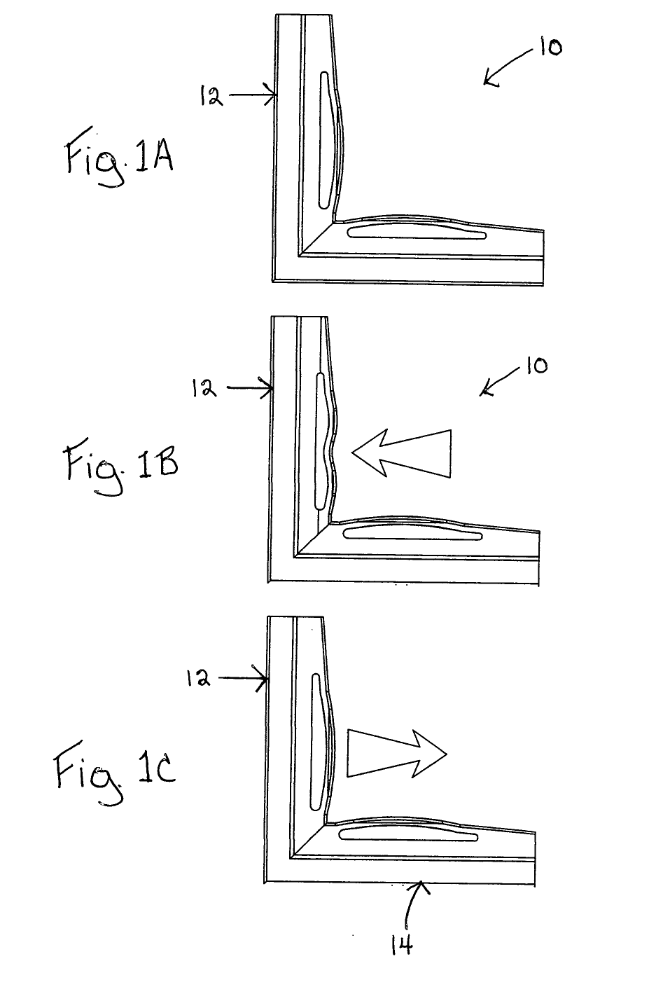

As shown in FIGS. 1A, 1B and 1C, corner member 10 may be inserted into a frame member such that leaf spring 24 is depressed inwardly as shown in FIG. 1B. Leaf spring 24 will then exert pressure on the frame member.

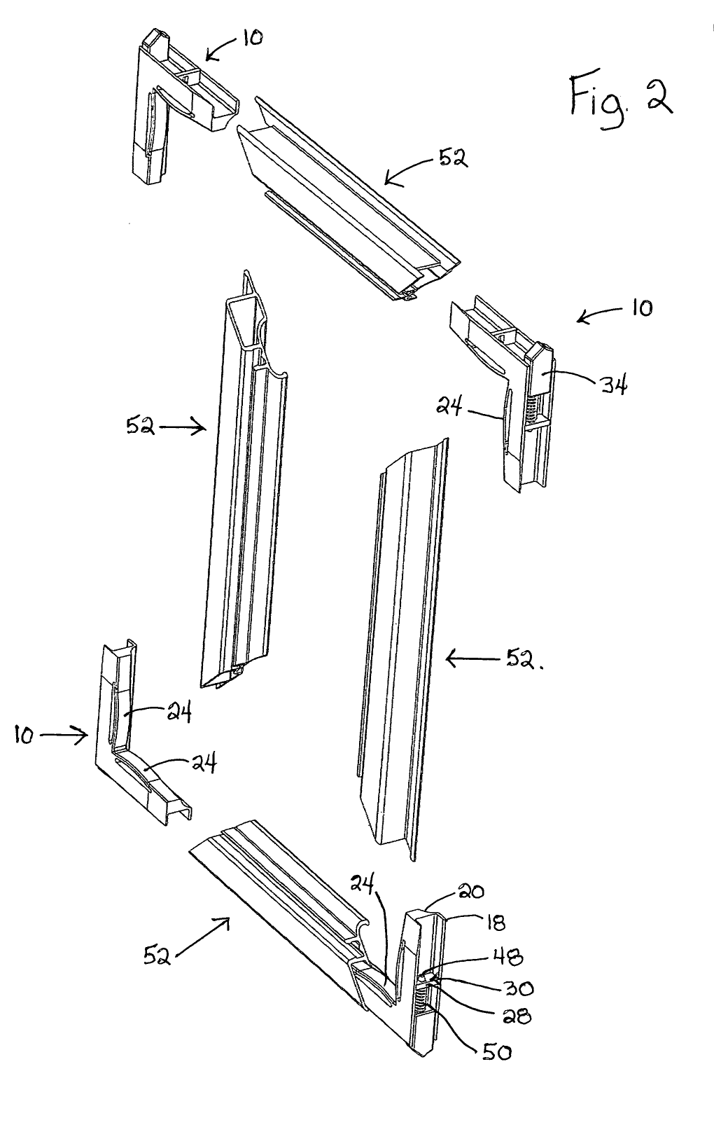

FIG. 2 illustrates the components which may be utilized to form a screen. Thus, there are frame members 52, each designed to receive a corner member 10 to form the finished assembly.

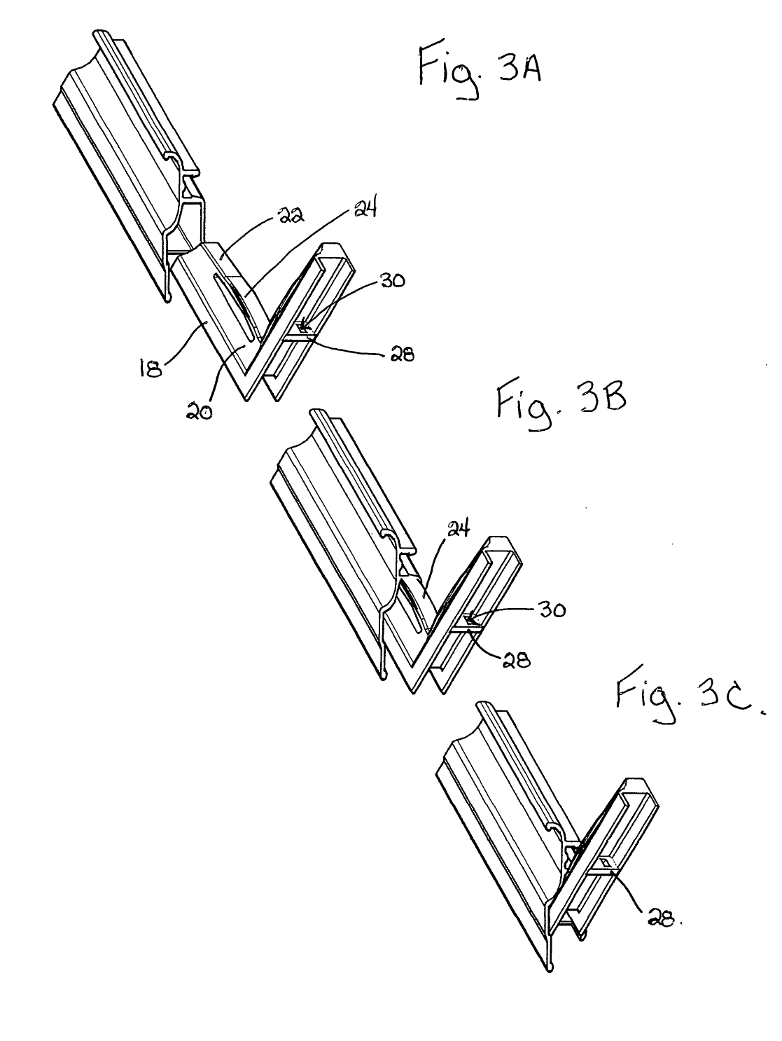

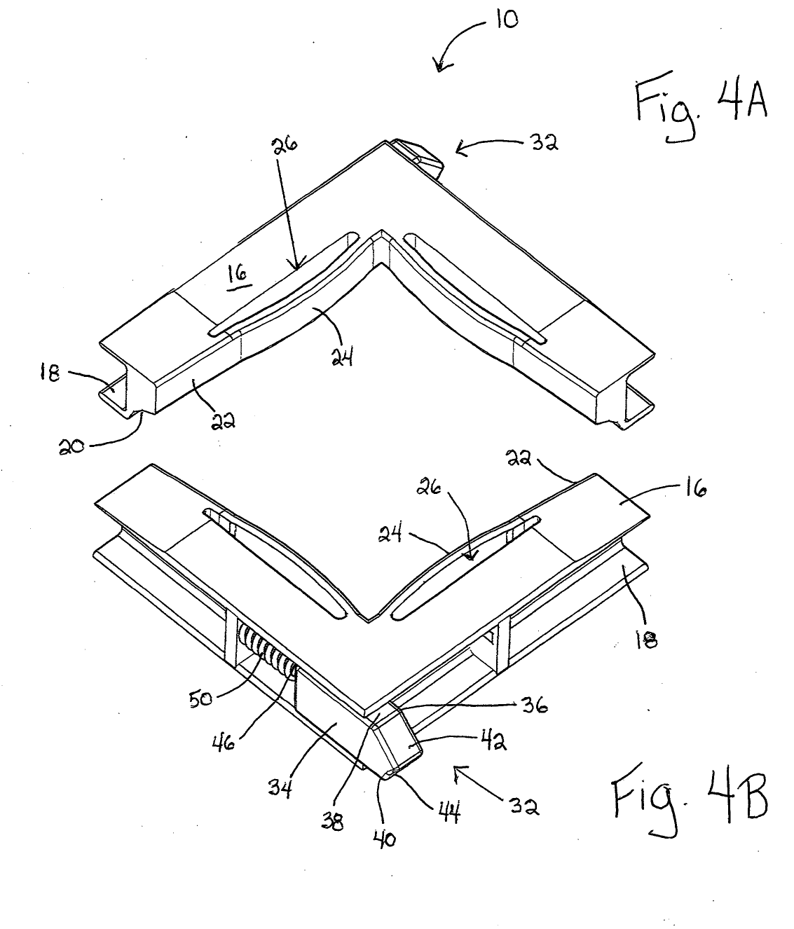

FIGS. 3A, 3B and 3C show the progressive insertion of a corner member 10 into a frame member 52.

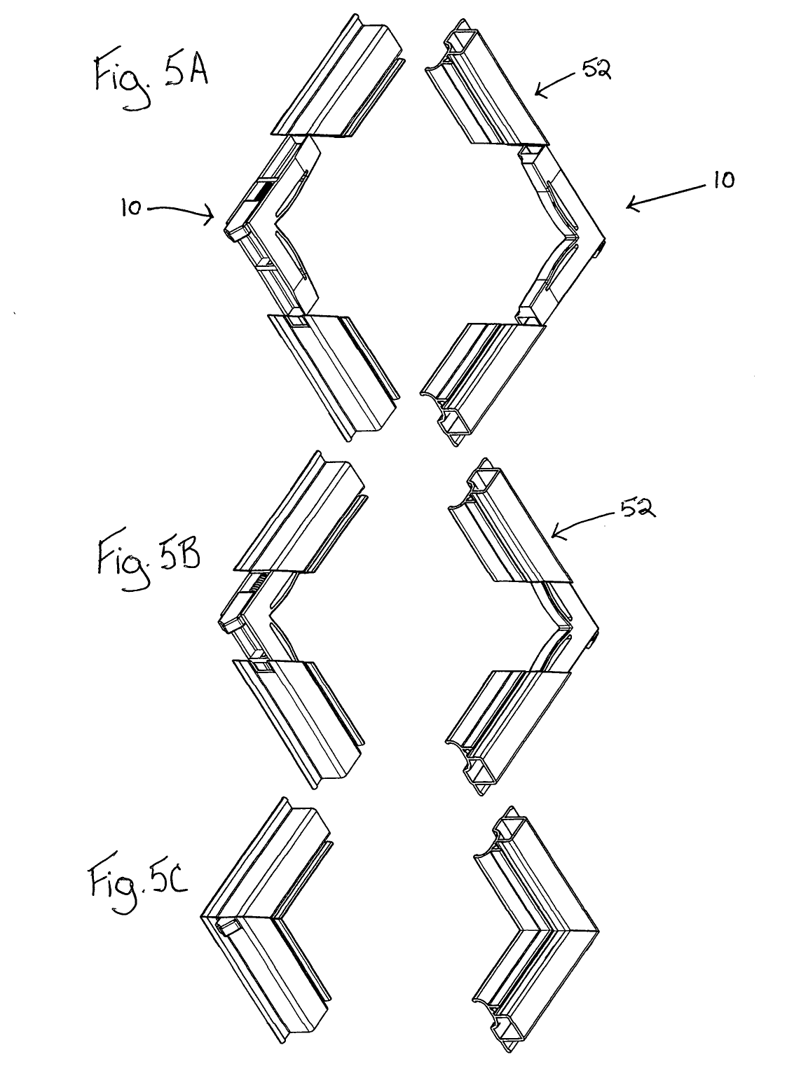

FIGS. 5A, 5B and SC likewise show the insertion of corner members into frame members 52.

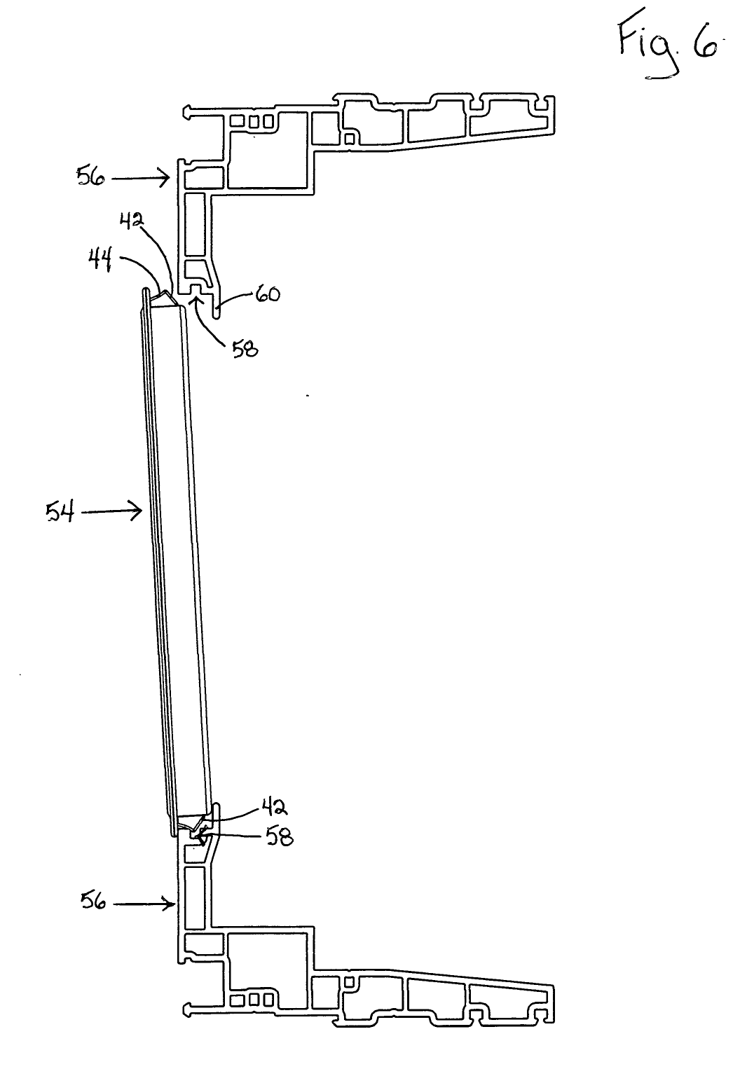

FIG. 6 illustrates the initial insertion of the screen frame into a window frame. In this regard, the bottom is initially placed in position followed by the top portion.

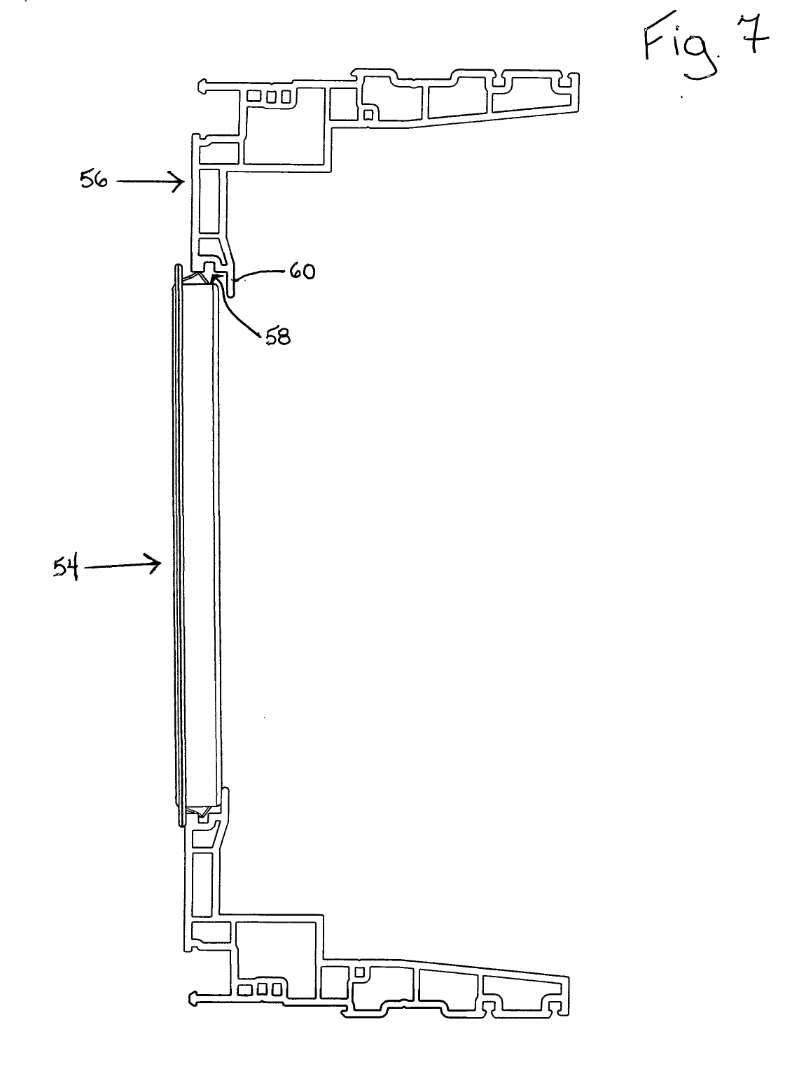

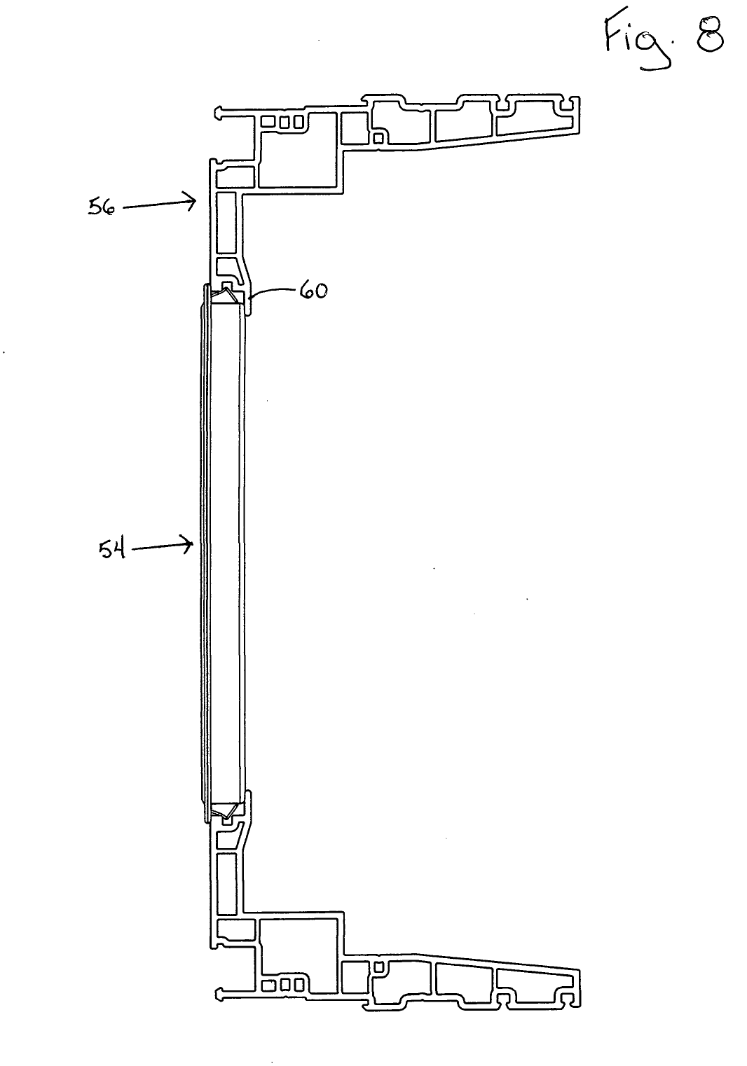

As seen in FIGS. 7 and 8, the screen frame is progressively inserted with top wall 42 facing inwardly towards the interior. A rectangular groove 58 is provided in both the top and bottom of window frame 56 to receive movable retaining member 32.

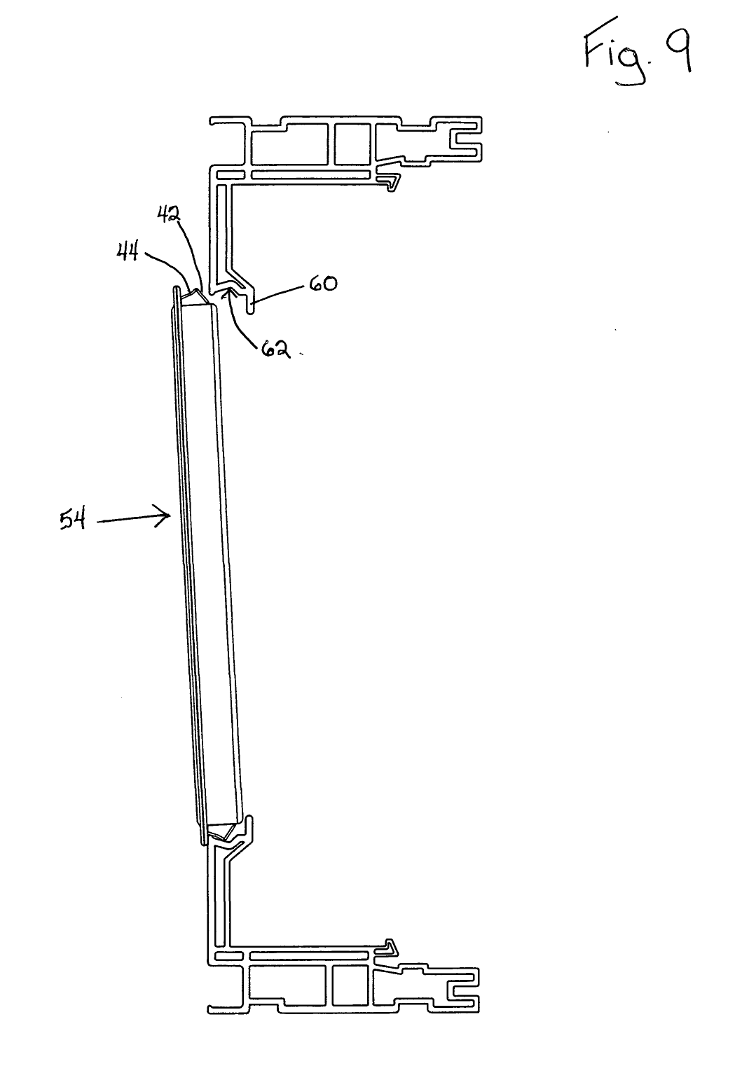

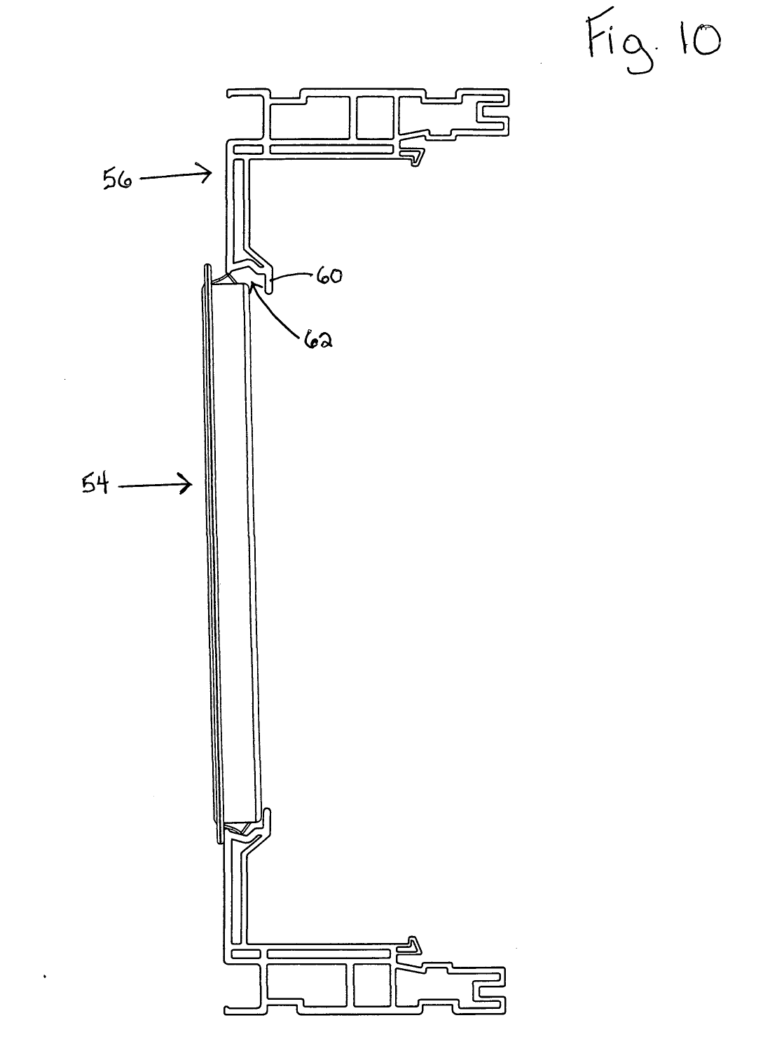

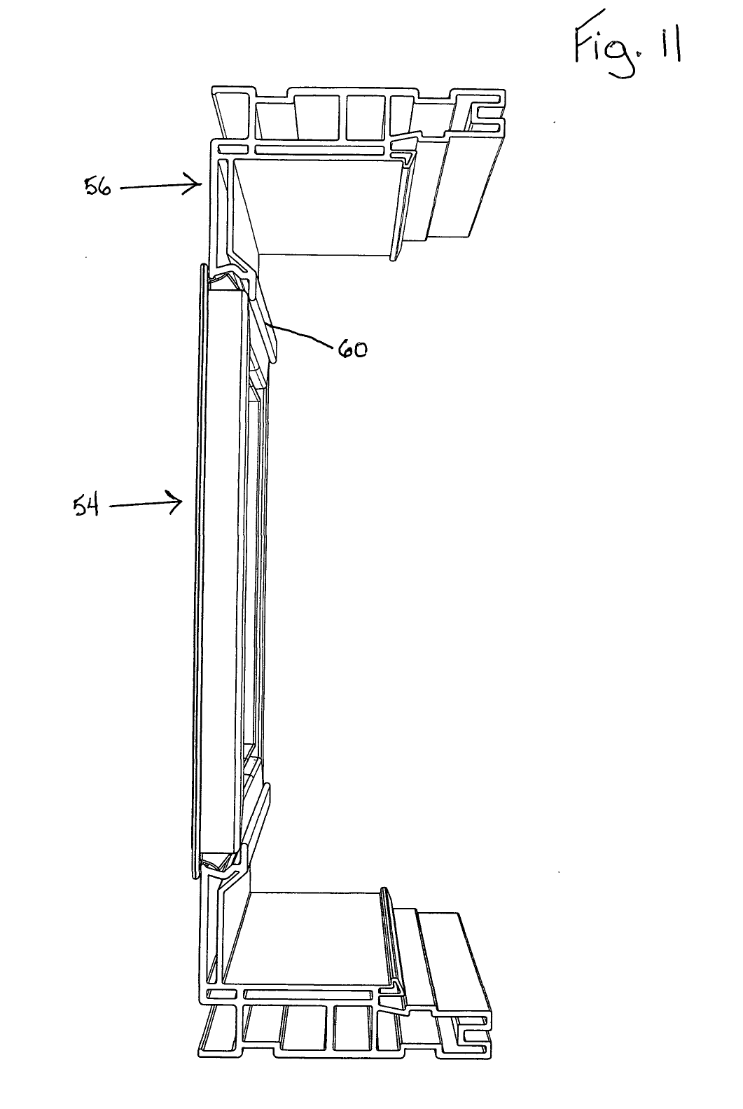

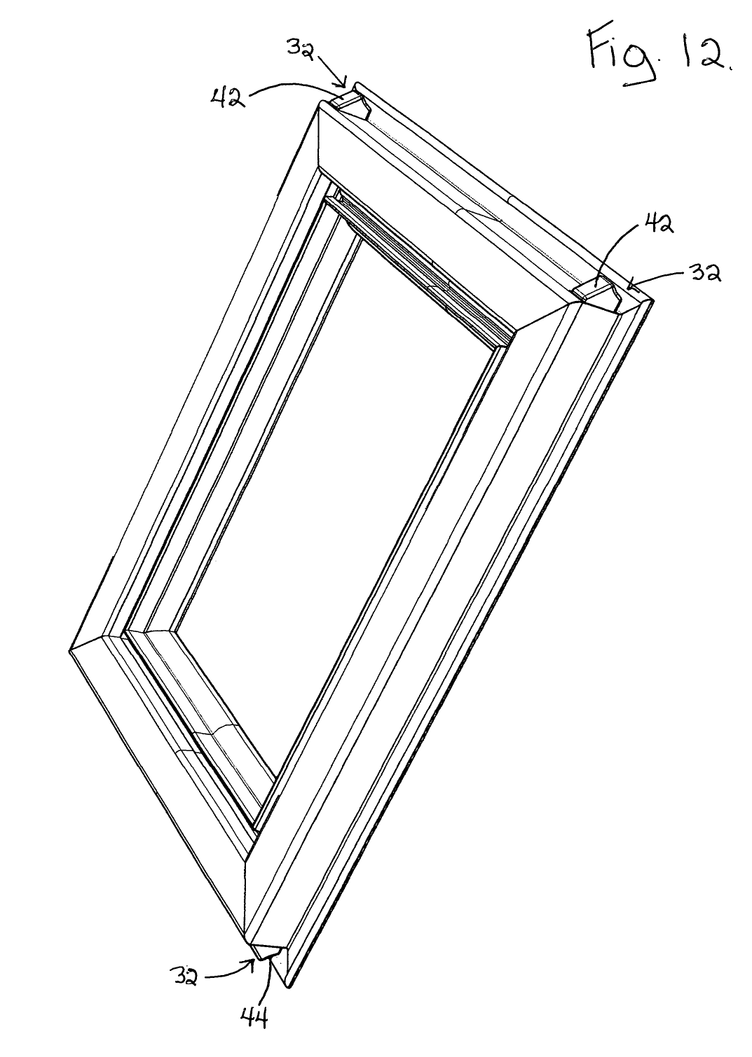

In the embodiment of FIGS. 9 to 11, an arcuate retaining groove 62 is utilized in both the top and bottom of the window frame 56. In both instances, a window frame flange 60 abuts the inner portion of the screen frame 54.

It will be understood that the above described embodiments are for purposes of illustration only and that changes and modification may be made thereto without departing from the spirit and scope of the invention.

I claim:

1. A corner member for use in connecting two screen frame members together, said corner member having first and second mutually connected legs, said first and second legs extending perpendicularly to each other, each of said legs having a main body portion and a leaf spring extending upwardly from one side of said main body portion, said leaf spring being slightly spaced from a portion of said one side of said main body portion, the arrangement being such that when each of said legs is inserted into one of said screen frame members, said leaf spring is compressed and functions to retain said screen frame member in position.

2. The corner member of claim 1 wherein said corner member has a movable member associated therewith, said movable member having an elongated configuration with a first end thereof being within a respective corner member and a second end thereof extending outwardly from said respective corner member, said second end having a triangular configuration defined by first and second sloping side walls meeting at an apex.

3. The corner member of claim 2 wherein said first and second sloping walls each have a different slope.

4. The corner member of claim 3 wherein said first sloping wall is located on the inward side of the screen member and is of a lesser slope than said second sloping wall.

5. The corner member of claim 3 wherein each of said movable members is biased outwardly by a spring member.

6. The corner member of claim 5 wherein said movable member has a shaft extending downwardly from said first end, said spring being located about said shaft, said shaft engaging a wall within said corner member and being retained in position thereby.

7. The frame for a screen comprising:
Four screen frame members;
Four corner members interconnecting the four screen frame members to form a rectangular screen frame;
Each of the four corner members having a movable member associated therewith, said movable member having an elongated configuration with a first end being within said corner frame member, and a second end extending outwardly from a respective corner member, the second end having a triangular configuration with first and second sloping sides meeting at an apex.
